(19) United States
(12) Patent Application Publication
(10) Pub. No.: US 2025/0254756 A1
(43) Pub. Date: Aug. 7, 2025

(54) Broadcast MBS Reception in Connected State

(71) Applicant: Apple Inc., CUPERTINO, CA (US)

(72) Inventors: Fangli XU, Beijing (CN); Haijing Hu, Los Gatos, CA (US); Dawei ZHANG, Saratoga, CA (US); Yuqin CHEN, Beijing (CN)

(21) Appl. No.: 18/854,307

(22) PCT Filed: Apr. 12, 2022
(86) PCT No.: PCT/CN2022/086342

§ 371 Date: Oct. 4, 2024

(51) Int. Cl. H04W 76/40; H04W 76/38

(52) U.S. Cl. CPC H04W 76/40; H04W 76/38

(57) ABSTRACT

A user equipment (UE) is configured to transmit a request to a network indicating an interest to receive a multicast and broadcast services (MBS) broadcast from a serving cell of the network, wherein the request includes identifying information for the serving cell including a cell index or frequency, determine whether a network response is received prior to expiration of a timer duration, when the network response is received before the expiration of the timer duration, acquire information for receiving the MBS broadcast from the serving cell and when the network response is not received before the expiry of the timer, perform operations triggered by the expiry of the timer.

### TECHNICAL FIELD

The present disclosure generally relates to communication, and in particular, to the broadcast MBS reception in connected state.

### BACKGROUND

Multicast and broadcast services (MBS) refers to 5G new radio (NR) network services in which the same content can be provided simultaneously to all user equipment (UEs) accessing the MBS service. Operations are defined for a UE to request MBS broadcast reception from a primary cell (PCell) and receive a system information block (SIB) from the network including configuration information for accessing the MBS service. However, UE and network operations are unclear with respect to requesting and providing the MBS broadcast reception configuration information for MBS broadcast receptions from a secondary cell (SCell).

### SUMMARY

Some exemplary embodiments are related to a processor of a user equipment (UE) configured to transmit a request to a network indicating an interest to receive a multicast and broadcast services (MBS) broadcast from a serving cell of the network, wherein the request includes identifying information for the serving cell including a cell index or frequency;, determine whether a network response is received prior to expiration of a timer duration, when the network response is received before the expiration of the timer duration, acquire information for receiving the MBS broadcast from the serving cell and when the network response is not received before the expiry of the timer, perform operations triggered by the expiry of the timer.

Other exemplary embodiments are related to a processor of a user equipment (UE) configured to transmit a request to a network indicating an interest to receive a multicast and broadcast services (MBS) broadcast from a cell of the network, wherein the cell is, when the request is transmitted, a secondary cell (SCell) of the UE, the request including identifying information for the cell including a cell index or frequency, receive SCell MBS reception related information from the network within a timer duration and receive the MBS broadcast from the SCell based on the SCell MBS reception related information.

Still further exemplary embodiments are related to a processor of a user equipment (UE) configured to transmit a request to a network indicating an interest to receive a multicast and broadcast services (MBS) broadcast from a cell of the network, wherein the cell is, when the request is transmitted, a secondary cell (SCell) of the UE, the request including identifying information for the cell including a cell index or frequency, receive a network reconfiguration within a timer duration wherein the cell is reconfigured from an SCell to a primary cell (PCell) and receive the MBS broadcast from the PCell.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a signaling diagram for MBS broadcast configuration and reception according to various exemplary embodiments described herein.

FIG. 5 shows a method for configuring a UE in the CONNECTED state for SCell MBS broadcast reception according to various exemplary embodiments.

FIG. 6a shows a signaling diagram for transmitting an SCell MBS reception request according to various exemplary embodiments.

FIG. 6b shows a signaling diagram for triggering the transmission of an SCell MBS reception request according to one example.

FIG. 7a shows a signaling diagram for a UE receiving SCell MBS reception related information from the network according to various exemplary embodiments.

FIG. 7b shows a signaling diagram for UE behavior when the SCell MBS reception related information is not received from the network according to various exemplary embodiments.

FIG. 8a shows a signaling diagram for UE operations when the UE receives the network response according to a first option.

FIG. 8b shows a signaling diagram for UE operations when the UE receives the network response according to a second option.

FIG. 8c shows a signaling diagram for UE operations when the UE receives the network response according to a variant of the second option.

FIG. 8d shows a signaling diagram for UE operations when the UE receives the network response according to a third option.

FIG. 8e shows a signaling diagram for UE operations when the UE receives the network response according to a fourth option.

FIG. 8f shows a signaling diagram for UE operations when the UE receives the network response according to a fifth option.

FIG. 8g shows a signaling diagram for UE operations when the UE receives the network response according to a sixth option.

### DETAILED DESCRIPTION

The exemplary embodiments may be further understood with reference to the following description and the related appended drawings, wherein like elements are provided with the same reference numerals. The exemplary embodiments describe network and user equipment (UE) operations for receiving multicast and broadcast services (MBS) broadcast transmissions at the UE. Specifically, the exemplary embodiments relate to receiving MBS transmissions from a secondary cell (SCell) when the UE is in the RRC CONNECTED state and interested in the SCell MBS services.

The exemplary embodiments are described with regard to a UE. Those skilled in the art will understand that the UE may be any type of electronic component that is configured to communicate via a network, e.g., mobile phones, tablet computers, desktop computers, smartphones, phablets, embedded devices, wearables, Internet of Things (IoT) devices, etc. Therefore, the UE as described herein is used to represent any electronic component that directly communicates with the network.

The exemplary embodiments are also described with regard to a 5G New Radio (NR) network. However, reference to a 5G NR network is merely provided for illustrative purposes. The exemplary embodiments may be utilized with any network implementing MBS methodologies similar to those described herein. Therefore, the 5G NR network as described herein may represent any type of network implementing similar MBS functionalities as the 5G NR network.

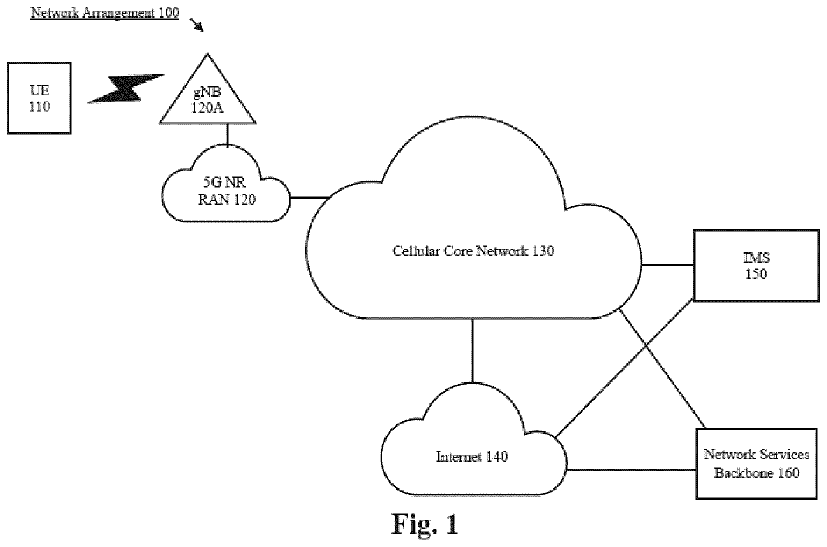

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables (e.g., HMD, AR glasses, etc.), Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a WLAN, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

The UE 110 may connect to the 5G NR-RAN 120 via the gNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

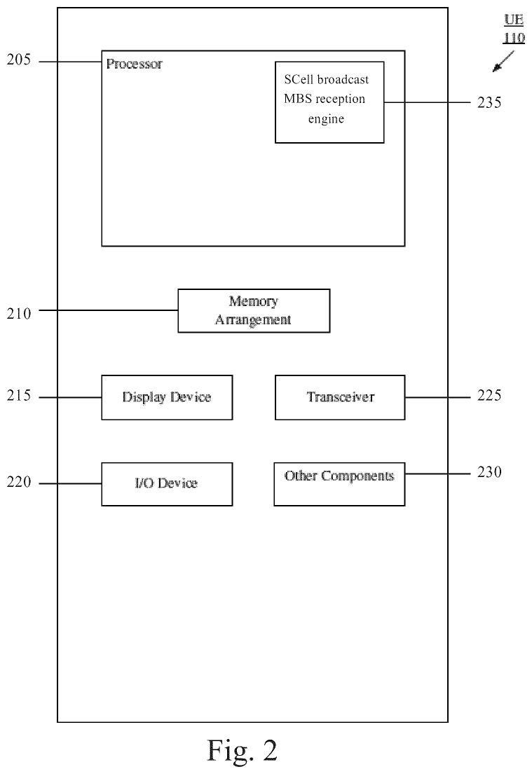

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a SCell broadcast MBS reception engine 235 for performing various operations related to receiving MBS broadcast transmissions from a SCell. These operations may include requesting the PCell for MBS services on the SCell and receiving configuration information from either one or both of the PCell and the SCell according to various options to be described in detail below.

The above referenced engine 235 being an application (e.g., a program) executed by the processor 205 is provided merely for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies).

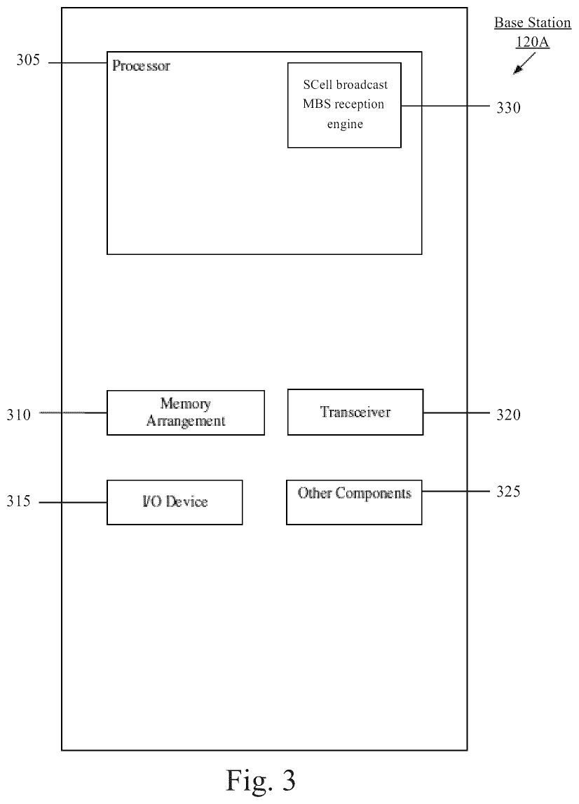

FIG. 3 shows an exemplary base station 300 according to various exemplary embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. For example, the engines may include a SCell broadcast MBS reception engine 330 for performing various operations related to receiving MBS broadcast transmissions from a SCell. These operations may include receiving a request for MBS services on the SCell of the UE and providing configuration information to the UE according to various options to be described in detail below.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs.

The multicast and broadcast services (MBS) broadcast transmission and reception scheme includes the following features. The same broadcast MBS service (e.g., content) is provided simultaneously to all UEs accessing the MBS service. All UEs can receive the broadcast MBS data without the special UE authorization or the special network operation.

To ensure broadcast MBS service continuity, e.g., to avoid an interruption in broadcast MBS service reception during a cell change (reselection), the following mechanisms are provided. For UEs in the IDLE/INACTIVE states, 1) the gNB can provide information to the UE related to service continuity for MBS broadcast reception and/or 2) the UE can prioritize the MBS frequencies during the cell reselection. For UEs in the CONNECTED state, the UE can send the MBS Interest Indication (MII) to the gNB via dedicated RRC signaling. The MII includes the following information: a list of MBS frequencies the UE is interested to receive, sorted in decreasing order of interest; a priority between the reception of all listed MBS frequencies and the reception of any unicast bearer; and a list of MBS broadcast services the UE is interested to receive, in case SIBx on these frequencies is scheduled by the UE PCell. The MII reporting can be implicitly enabled/disabled by the presence of SIBx1. It should be understood that the information being provided via a SIB may be provided in any currently defined or future SIB. Thus, the use of SIBx is referring to either a SIB that has not yet been numbered or any of the currently numbered SIBs.

With regard to network operations after receiving the MII, the gNB can use the MII together with the UE capabilities (e.g., supported band combinations) to provide the unicast RRC configuration and scheduling for MBS reception to allow the UE to receive the MBS services.

The UE in the CONNECTED state can report the MII, e.g., indicate interest in receiving MBS broadcast services, to trigger a MBS broadcast configuration acquisition procedure.

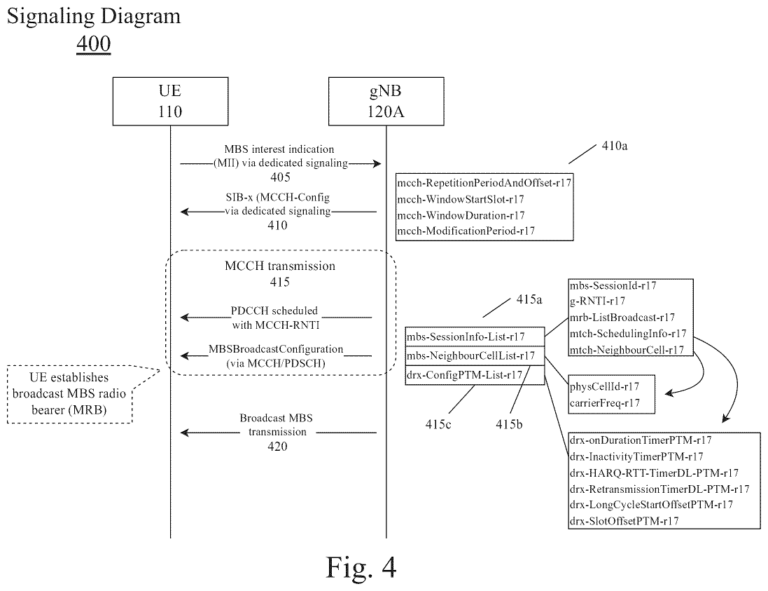

FIG. 4 shows a signaling diagram 400 for MBS broadcast configuration and reception according to various exemplary embodiments described herein.

In 405, the UE in the CONNECTED state indicates interest in receiving the MBS broadcast (e.g., reports MII) as described above.

In 410, the UE receives system information including an MBS Control Channel (MCCH) configuration (MCCH-Config) from the serving gNB via dedicated signaling. The MCCH-Config can be carried in a system information block (SIB) referred to herein as “SIB-x” or “SIB-20.” The SIB-x as referenced herein can be a new SIB type and those skilled in the art will understand that the new SIB-20 may be referred to as a different SIB # in the 3GPP standards. As shown in 410a, the MCCH-Config can include parameters for i) repetition period and offset, ii) window start slot, iii) window duration, and (iv) modification period, e.g., similar to a search space configuration.

In 415, the UE receives the MCCH transmission according to the MCCH configuration provided in 410. The MCCH carries a scheduling downlink control information (DCI) and the MBS broadcast configuration for receiving broadcast MBS services. The MCCH provides the list of all broadcast services with ongoing sessions transmitted on the MBS traffic channel(s) (MTCH) and the associated information for the broadcast session (e.g., MBS session ID, group radio network temporary identifier (G-RNTI) and scheduling info), as shown in 415a, neighbor cell information for MTCH, as shown in 415b, and DRX information, as shown in 415c. The MBS broadcast configuration can also be received via the physical downlink shared channel (PDSCH).

From the MBS broadcast configuration, the UE can establish the broadcast MBS radio bearer (MRB) for receiving the broadcast MBS transmissions. The UE establishes the Service Data Adaption Protocol (SDAP) entity, the Packet Data Convergence Protocol (PDCP) entity, and the Radio Link Control (RLC) entity. The UE applies the PHY configuration and informs the upper layers about the temporary mobile group identity (TMGI) for identifying the MBS bearer service.

In 420, the UE receives the broadcast MBS transmission on the MTCH.

According to current specification, the UE can receive the broadcast MBS on a non-PCell in RRC CONNECTED state. For a non-serving cell, the UE in any of the RRC IDLE/INACTIVE/CONNECTED states can receive the MBS broadcast on the non-serving cell under the condition that this does not have any impact to operation on serving cell(s), e.g., the MBS broadcast reception on the non-serving cell is up to UE implementation and transparent to the network. For a secondary cell group (SCG), MBS on SCG is not supported.

For an SCell, MBS broadcast reception is allowed for the UE in the CONNECTED state. The UE is not required to receive the system information carrying the MCCH-Config (e.g., SIB-x as described above in 410) on the SCell. For example, the network can provide the SIB-x to the UE by dedicated signaling.

Thus, according to current agreement, the network can provide the SIB-x to the UE to inform the broadcast MBS configuration on the SCell. However, the network behavior for the SIB-x provision on the SCell is unclear. For example, it is unclear how the gNB decides to provide the SIB-x to the UE for the SCell broadcast MBS reception. Additionally, the UE behavior on the SCell MBS reception is unclear. For example, it is unclear what the UE should expect on the SCell SIB-x provision from the gNB and what the UE behavior should be if the UE intends to receive the MBS on the SCell but does not receive the SIB-x from the gNB via dedicated signaling.

According to various exemplary embodiments described herein, operations are described for a user equipment (UE) to receive a multicast and broadcast services (MBS) broadcast configuration and MBS transmissions from a secondary cell (SCell) of a radio access network (RAN), e.g., the 5G RAN. As described above, the operations for receiving MBS broadcasts from a primary cell (PCell) are well defined, however, the operations for receiving MBS broadcasts from the SCell are presently unclear. Various options are available for specifying the UE and network behavior to provide MBS broadcast services to the UE.

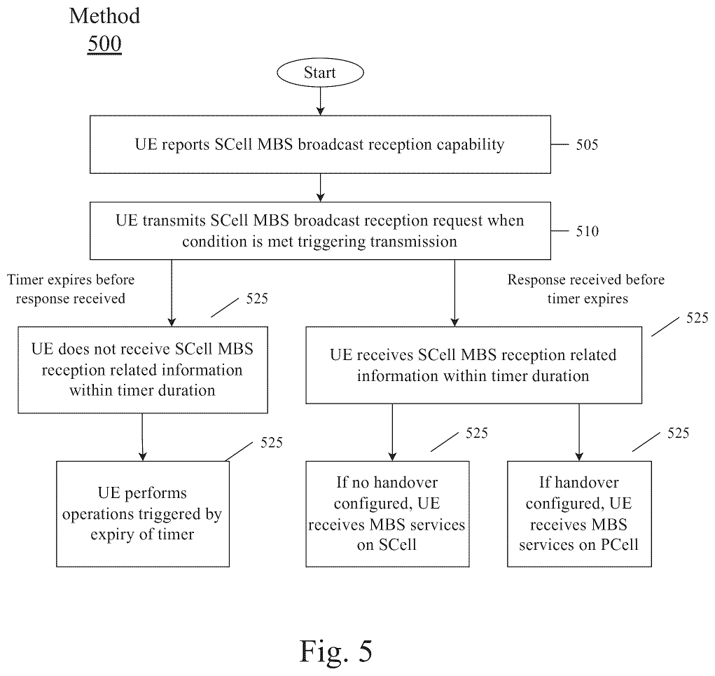

In the following, the general procedure for the UE to receive the SCell MBS configuration in the CONNECTED state, and subsequently perform MBS receptions, will be described with regard to the method 500 of FIG. 5. Reference will also be made to operations described above for the signaling diagram 400 of FIG. 4.

FIG. 5 shows a method 500 for configuring a UE in the CONNECTED state for SCell MBS broadcast reception according to various exemplary embodiments.

In one aspect of these exemplary embodiments, a new UE capability is defined. The new capability may be referred to as the “SCell MBS broadcast reception capability” and is used to indicate UE support for the reception of the MCCH/MTCH on the SCell. The new capability can be designed as per UE, per band, per band combination, per feature set, or per feature set per component carrier.

In 505, the UE reports the SCell MBS broadcast reception capability to the network as described above. The UE can report the new capability during, e.g., during initial registration.

In another aspect of these exemplary embodiments, the UE informs the network, e.g., the PCell, via dedicated signaling of the UE interest to receive the broadcast MBS on the SCell. In addition, the UE can inform the network of the SCell frequency/index in which the UE is interested. This information can be carried in a message referred to herein as the “SCell MBS broadcast reception request.”

The message can be designed so that the UE can report the SCell index/frequency and, optionally, the interested MBS service ID. Multiple options are available regarding message types used to carry this information.

As described in detail above, the MBS interest indication (MII) can be used by the UE in the CONNECTED state, e.g., reported via an on-demand SIB request in dedicated signaling, to request MBS services from the serving cell. The MII can trigger the network to initiate the MBS broadcast configuration acquisition procedure, as described above in signaling steps 410, 415 of FIG. 4. However, the MII is not currently specified for use in requesting MBS services from an SCell.

In a first option for the SCell MBS reception request, the message can be transmitted in the MII. The MII message can be modified to include an SCell index or frequency parameter that, when included in the MII, indicates the identity of the SCell from which the UE has interest in receiving MBS broadcast services. In this option, the UE can enable the MII reporting after receiving from the network an explicit SCell MBS reception indication, to be explained in further detail below.

In a second option for the SCell MBS reception request, the message can be transmitted in UE assistance information (UAI) or other types of UL unicast L1/L2/L3 messages.

In a third option for the SCell MBS reception request, the message can be transmitted based on the on-demand SI acquisition procedure, to be explained in greater detail below.

In one embodiment, if MII is enabled by SIB-x, the UE can report the SCell MBS information via MII (according to the first option). Otherwise, if MII is not enabled, the UE can report the information via the second or third options.

In still another option, the existing MII can be used and the network can decide whether the SCell SIB-x should be provided.

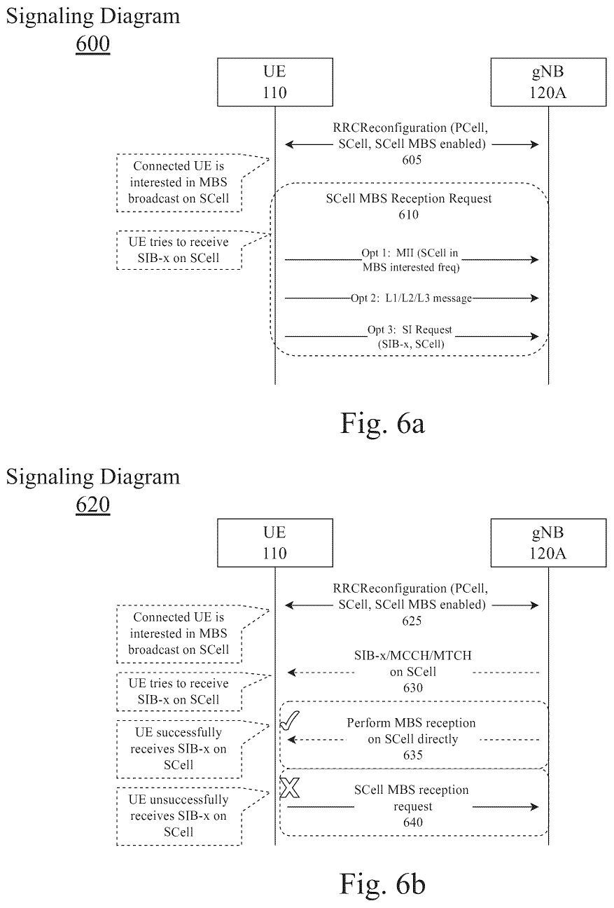

FIG. 6a shows a signaling diagram 600 for transmitting an SCell MBS reception request according to various exemplary embodiments. In 605, the UE in the CONNECTED state receives an RRC reconfiguration including a configuration for a PCell, a first SCell (SCell 1) and a second SCell (SCell 2). The UE further receives an indication in the RRC reconfiguration that SCell MBS services are enabled. After the reconfiguration, the UE is interested in the MBS broadcast on the SCell.

In 610, the UE transmits the SCell MBS reception request according to any of the three options discussed above.

In another aspect of these exemplary embodiments, the SCell MBS reception request can be triggered for reporting by the UE when one or more conditions are met.

In a first condition for transmitting the SCell MBS reception request, the UE receives a network indication that 1) the network can provide the SCell SIB-x to the UE via dedicated signaling or 2) the network supports using the MII trigger for SIB_x1. In a second condition for transmitting the SCell MBS reception request, the UE intends to receive the MBS broadcast on the SCell (is interested in the MBS services). Optionally, the UE can attempt by UE implementation to receive the MBS configuration in a SIB-x broadcast transmitted by the SCell, and the SCell MBS reception request is transmitted only when the UE is unable to receive the SIB-x.

FIG. 6b shows a signaling diagram 620 for triggering the transmission of an SCell MBS reception request according to one example. The signaling diagram 620 of FIG. 6b illustrates the UE operations when the second condition discussed above is met, e.g., where the UE attempts to acquire the SIB-x directly from the SCell according to UE implementation.

In 625, the UE in the CONNECTED state receives an RRC reconfiguration, similar to 605 above, including a configuration for a PCell, a SCell 1, a SCell 2, and an indication that SCell MBS services are enabled. After the reconfiguration, the UE is interested in the MBS broadcast on the SCell.

In 630, the UE attempts to acquire the SIB-x on SCell-1 directly according to UE implementation. In 635, if the UE is successful in acquiring the SIB-x, the UE receives the MCCH and the MTCH directly from the SCell without requesting or acquiring the SIB-x from the PCell. In 640, if the UE is unsuccessful in acquiring the SIB-x, the UE transmits the SCell MBS reception request, e.g., according to any of the three options discussed above.

In a third condition for transmitting the SCell MBS reception request, the UE does not receive the network response for some duration (timer controlled) after the previous SCell MBS broadcast interest information is transmitted, e.g., the UE retriggers the MII transmission, to be described in further detail below. In a fourth condition for transmitting the SCell MBS reception request, where UE interest on the SCell MBS broadcast service has changed. For example, the UE may have a new interest in receiving MBS broadcast transmissions from a different cell. In a fifth condition for transmitting the SCell MBS reception request, the SCell with UE interested MBS reception changes into the non-serving cell or the non-serving cell is configured as the SCell.

Returning to the method 500 of FIG. 5, in 510, the UE transmits an SCell MBS broadcast reception request to the network (e.g., the gNB/PCell). As described above, the UE can report its SCell MBS interest to the network in a variety of ways and based on a variety of trigger conditions. In some embodiments, the request may be similar to the MII described in 405 of FIG. 4.

According to another aspect of these exemplary embodiments, network operations are described with respect to enabling/disabling the reporting of the UE SCell MBS broadcast reception request and the network behavior when the SCell MBS broadcast reception request is received from the UE.

The network can enable the UE SCell interest reporting according to at least the following three options. In a first option, the network can enable/disable the SCell MBS interested reporting explicitly in the RRCReconfiguration. In a second option, the network broadcasts SIB-x to implicitly enable/disable the SCell MBS interested reporting. In a third option, the network enables the reporting via the specific indication in the broadcast SIB.

The network can provide the SCell MBS broadcast related configuration to the UE according to at least the following six options. In each of the following options, the SCell identity is also indicated. In a first option, the network can provide the SCell SIB-x via dedicated RRC Reconfiguration. In a second option, the network can reconfigure the SCell to PCell (e.g., in a handover command) and, optionally, provide the SIB-x of the target PCell in the same HO command. If the SIB-x of the target PCell is not provided, the UE can implement MBS reception operations on the new PCell according to the procedure described above, e.g., in FIG. 4. In a third option, the network can provide the SIB-x of the SCell to the UE via the dedicated SI acquisition process, e.g., when the UE transmits the SCell MBS reception request as part of the on-demand SI request.

In a fourth option, the network can provide the MCCH configuration directly to the UE in RRC signaling. The RRC signaling could optionally include the SIB-x of the SCell. In a fifth option, the network can provide the UE interested MBS service scheduling info (MTCH) to the UE directly. In a sixth option, the network can provide the scheduling of the SIB-x transmission on SCell to UE. In one variant, the network can configure the CORESET and search space on SCell for SIB-x reception via dedicated signaling. In another variant, the CORESET and search space configuration on SCell for SIB-x reception can be broadcast on the PCell.

If the UE interested information has not changed, but the network configuration for the MBS services is changed, the network can provide the updated information to the UE without receiving additional UE information.

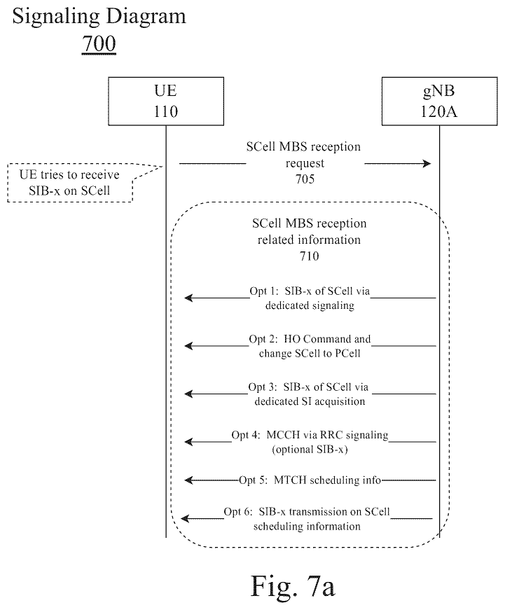

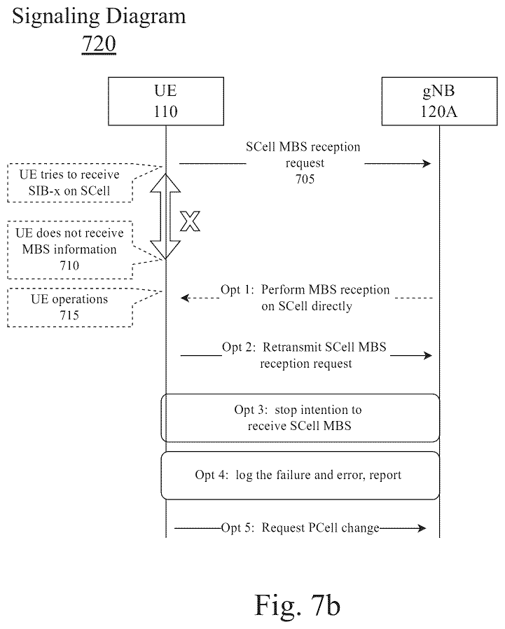

FIG. 7a shows a signaling diagram 700 for a UE receiving SCell MBS reception related information from the network according to various exemplary embodiments. In 705, the UE transmits the SCell MBS reception request and triggers the network to provide SCell MBS reception related information. In 710, the UE receives the SCell MBS reception related information according to any of the six options discussed above.

The options discussed above assume that the network will provide the UE with the SCell MBS reception related information in response to the UE request. However, in some scenarios, the UE will not receive a response from the network within some predetermined timer duration. When the UE does not receive the response, the UE can perform operations according to at least the following three options.

In a first option, the UE attempts to receive the SIB-x on the SCell according to UE implementation. In a second option, the UE re-transmits the SCell MBS reception request message. In a third option, the UE stops attempting to receive SCell MBS services, e.g., stops the intention to receive SCell MBS services, and prioritizes receiving the unicast transmissions from the network. In a fourth option, the UE logs the MBS SCell reception failure due to no SIB-X provision, and reports it to the network later via a log report, e.g., MDT. In a fifth option, the UE either requests handover to the SCell or performs the reestablishment procedure to camp on the interested SCell.

FIG. 7b shows a signaling diagram 720 for UE behavior when the SCell MBS reception related information is not received from the network according to various exemplary embodiments. In 705, the UE transmits the SCell MBS reception request. In 710, the UE does not receive the SCell MBS reception related information within the timer duration. In 715, the UE performs operations triggered by the expiry of the timer according to any of the five options discussed above.

Returning to the method 500 of FIG. 5, after the UE transmits the MBS broadcast reception request, similar to 710 above, the UE waits for the network response for a predetermined duration (e.g., timer controlled). In 515, the UE does not receive the SCell MBS reception related information within the timer duration. In 520, according to the five options discussed above, the UE performs operations triggered by the expiry of the timer.

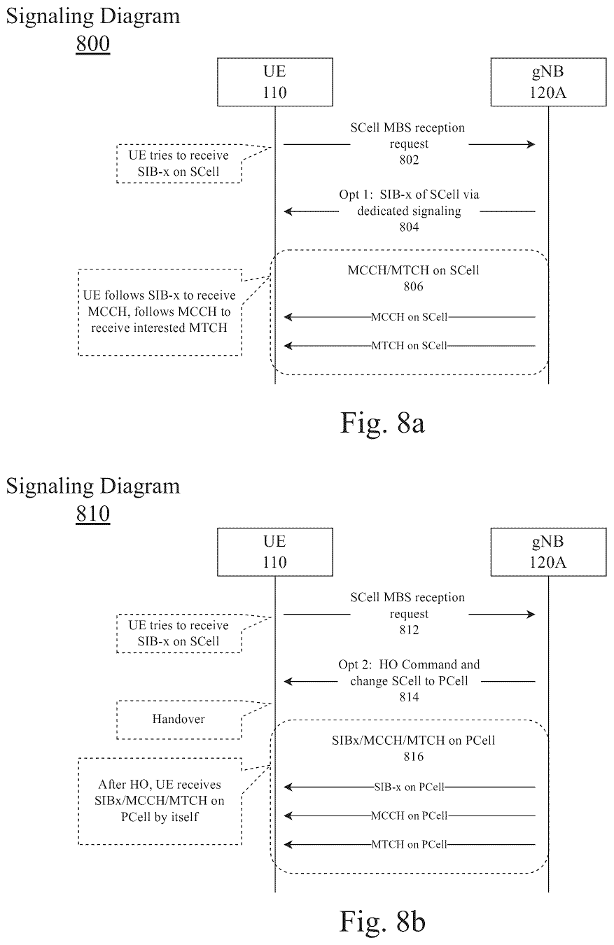

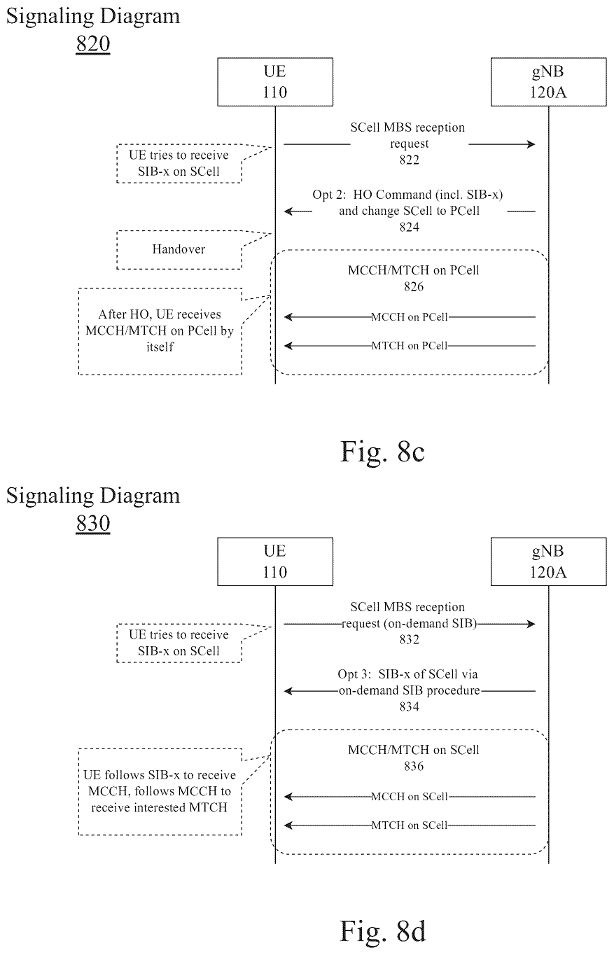

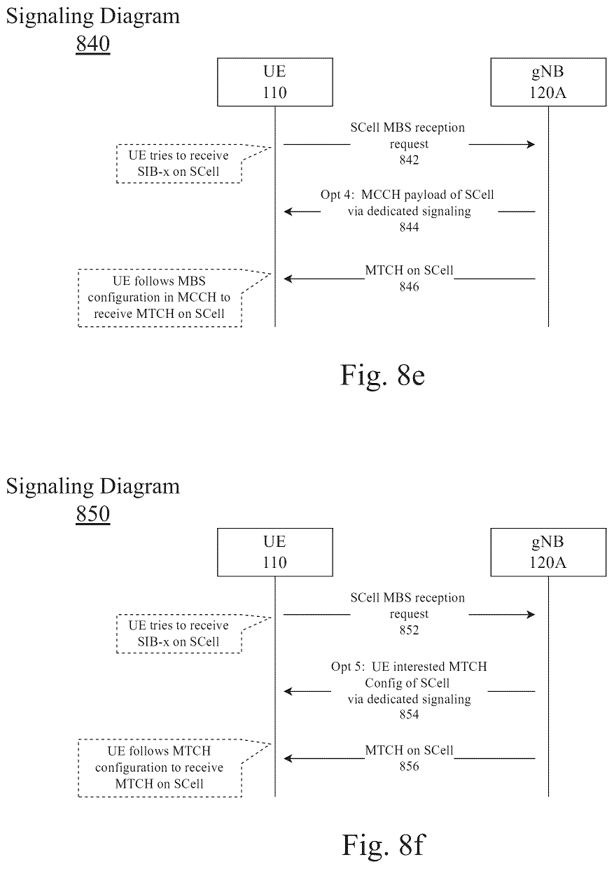

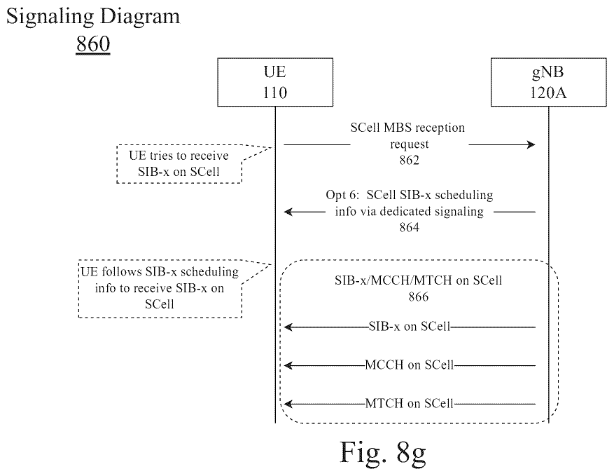

In another aspect of these exemplary embodiments, UE operations are described after receiving the SCell MBS broadcast related configuration from the network. The UE behavior depends on the process used by the network to provide the information, e.g., any of the six options and variants discussed above, as will be described in association with the signaling diagrams 800-860 described below in FIGS. 8a-g.

FIG. 8a shows a signaling diagram 800 for UE operations when the UE receives the network response according to a first option. In 802, the UE transmits the SCell MBS reception request to the network. In 804, according to the first option, the UE receives the SCell SIB-x via dedicated RRC Reconfiguration.

In 806, the UE receives the MCCH and the MTCH on the SCell. The UE receives the MCCH based on the MCCH configuration carried in the SIB-x and receives the MTCH based on the MBS configuration carried on the MCCH.

FIG. 8b shows a signaling diagram 810 for UE operations when the UE receives the network response according to a second option. In 812, the UE transmits the SCell MBS reception request to the network. In 814, according to the second option, the network reconfigures the SCell to PCell (e.g., in a handover command) and, in this example, does not provide the SIB-x of the target PCell in the HO command.

In 816, after handover, the UE receives the SIB-x, the MCCH and the MTCH on the new PCell (formerly SCell) providing the interested MBS services. The UE receives the MCCH based on the MCCH configuration carried in the SIB-x and receives the MTCH based on the MBS configuration carried on the MCCH.

FIG. 8c shows a signaling diagram 820 for UE operations when the UE receives the network response according to a variant of the second option. In 822, the UE transmits the SCell MBS reception request to the network. In 824, according to the second option, the network reconfigures the SCell to PCell (e.g., in a handover command) and, in this example, provides the SIB-x of the target PCell in the same HO command.

In 826, after handover, the UE receives the MCCH and the MTCH on the new PCell (formerly SCell) providing the interested MBS services. The UE receives the MCCH based on the MCCH configuration carried in the SIB-x (included in the HO command from the previous SCell) and receives the MTCH based on the MBS configuration carried on the MCCH.

FIG. 8d shows a signaling diagram 830 for UE operations when the UE receives the network response according to a third option. In 832, the UE transmits the SCell MBS reception request to the network. In this example, the request is transmitted in accordance with the dedicated SI acquisition process, e.g., as part of the on-demand SI request. In 834, according to the third option, the network provides the SIB-x of the SCell to the UE via the dedicated SI acquisition process.

In 836, the UE receives the MCCH and the MTCH on the SCell. The UE receives the MCCH based on the MCCH configuration carried in the SIB-x and receives the MTCH based on the MBS configuration carried on the MCCH.

FIG. 8e shows a signaling diagram 840 for UE operations when the UE receives the network response according to a fourth option. In 842, the UE transmits the SCell MBS reception request to the network. In 844, according to the fourth option, the network provides the MCCH payload (MBS configuration, e.g., MTCH configuration) directly to the UE in RRC signaling and, in this example, also includes the SIB-x of the SCell. However, providing the SIB-x is optional.

In 846, the UE receives the MTCH on the SCell based on the MBS configuration included in the MCCH payload and, in this example, further based on the MCCH configuration carried in the SIB-x.

FIG. 8f shows a signaling diagram 850 for UE operations when the UE receives the network response according to a fifth option. In 852, the UE transmits the SCell MBS reception request to the network. In 854, according to the fifth option, the network provides the MTCH configuration to the UE directly via RRC signaling.

In 856, the UE receives the MTCH on the SCell based on the scheduling information received from the network.

FIG. 8g shows a signaling diagram 860 for UE operations when the UE receives the network response according to a sixth option. In 862, the UE transmits the SCell MBS reception request to the network. In 864, according to the sixth option, the network provides the scheduling of the SIB-x transmission on the SCell to the UE.

In 866, the UE receives the SIB-x, the MCCH and the MTCH on the SCell. The UE receives the SIB-x based on the scheduling information received from the network, receives the MCCH based on the MCCH configuration carried in the SIB-x, and receives the MTCH based on the MBS configuration carried on the MCCH.

As discussed above, in the sixth option, the network can configure the CORESET and search space on the SCell for SIB-x reception via dedicated signaling or via broadcast.

Returning to the method 500 of FIG. 5, in 525, the UE receives the network response and starts to perform the broadcast MBS reception. As described above, the UE behavior depends on the type of response received by the network. In 530, in the scenarios where the UE does not receive a handover command switching the SCell as the target PCell, the UE receives the MBS broadcast reception configuration and receives traffic on the MTCH from the SCell. In 535, in the scenarios where the UE receives the handover command switching the SCell as the target PCell, the UE receives the MBS broadcast reception configuration and receives traffic on the MTCH from the PCell.

In another aspect of these exemplary embodiments, the network can, in addition to providing to the UE the information related to the SCell, provide to the UE PCell or SCG related broadcast MBS reception related information. For example, during handover, the network can provide the PCell related information to the UE via dedicated signaling.

In still another aspect of these exemplary embodiments, after the UE receives the SIB-x on the SCell, the UE can continue using the MBS configuration even after the network releases the SCell. The UE can trigger the UE interested (SCell) MBS information to the network based on the configured serving cell set change. For example, the UE can trigger the report when the previous SCell with UE interested MBS broadcast service is released, or UE interested MBS broadcast service is on the newly added SCell.

### EXAMPLES

In a first example, a processor of a user equipment (UE) is configured to transmit a request to a network indicating an interest to receive a multicast and broadcast services (MBS) broadcast from a serving cell of the network, wherein the request includes identifying information for the serving cell including a cell index or frequency, determine whether a network response is received prior to expiration of a timer duration, when the network response is received before the expiration of the timer duration, acquire information for receiving the MBS broadcast from the serving cell and when the network response is not received before the expiry of the timer, perform operations triggered by the expiry of the timer.

In a second example, the processor of the first example, wherein the request is triggered upon the expiry of the timer started when a previous request was transmitted.

In a third example, the processor of the first example, wherein the request is triggered when the UE interest in the MBS broadcast on the cell is changed.

In a fourth example, the processor of the first example, wherein the request is triggered when a secondary cell (SCell) is reconfigured into a non-serving cell or the non-serving cell is configured as the SCell.

In a fifth example, the processor of the fourth example, wherein the capability is per-UE, per band, per band combination, per feature set, or per feature set per component carrier.

In a sixth example, the processor of the first example, further configured to report a secondary cell (SCell) MBS broadcast reception capability to the network indicating the UE supports the reception of the MBS broadcast on an SCell.

In a seventh example, the processor of the first example, wherein the operations triggered by the expiry of the timer include attempting to acquire system information block 20 (SIB-20) on a secondary cell (SCell) by UE implementation.

In an eighth example, the processor of the first example, wherein the operations triggered by the expiry of the timer include re-transmitting the request.

In a ninth example, the processor of the first example, wherein the operations triggered by the expiry of the timer include changing the interest for receiving the MBS broadcast.

In a tenth example, the processor of the first example, wherein the operations triggered by the expiry of the timer include logging a MBS SCell reception failure due to no provision of system information block 20 (SIB-20) on a secondary cell (SCell) and reporting the reception failure.

In an eleventh example, the processor of the first example, wherein the operations triggered by the expiry of the timer include requesting a handover to the cell to change the serving cell to a primary cell (PCell) or performing a reestablishment procedure to camp on the cell as the PCell.

In a twelfth example, a user equipment (UE) comprises a transceiver configured to communicate with a network and a processor communicatively coupled to the transceiver and configured to transmit a request to the network indicating an interest to receive a multicast and broadcast services (MBS) broadcast from a serving cell of the network, wherein the request includes identifying information for the serving cell including a cell index or frequency, determine whether a network response is received prior to expiration of a timer duration, when the network response is received before the expiration of the timer duration, acquire information for receiving the MBS broadcast from the serving cell and when the network response is not received before the expiry of the timer, perform operations triggered by the expiry of the timer.

In a thirteenth example, a processor of a base station is configured to receive a serving cell multicast and broadcast services (MBS) broadcast reception capability from a user equipment (UE), enable the UE to transmit a request indicating an interest to receive an MBS broadcast from a serving cell, receive the request from the UE including identifying information for the serving cell including a cell index or frequency and provide to the UE information for receiving the MBS broadcast from the serving cell.

In a fourteenth example, the processor of the thirteenth example, wherein the serving cell is, when the request is received, a secondary cell (SCell) of the UE.

In a fifteenth example, the processor of the thirteenth example, wherein the base station enables the UE to transmit the request via dedicated signaling.

In a sixteenth example, the processor of the thirteenth example, wherein the base station enables the UE to transmit the request by transmitting system information block 20 (SIB-20) on a secondary cell (SCell).

In a seventeenth example, the processor of the sixteenth example, wherein the SIB-20 on the SCell includes a specific indication enabling the UE request.

In an eighteenth example, a base station comprises a transceiver configured to communicate with a user equipment (UE) and a processor communicatively coupled to the transceiver and configured to receive a serving cell multicast and broadcast services (MBS) broadcast reception capability from the UE, enable the UE to transmit a request indicating an interest to receive an MBS broadcast from a serving cell, receive the request from the UE including identifying information for the serving cell including a cell index or frequency and provide to the UE information for receiving the MBS broadcast from the serving cell.

In a nineteenth example, a processor of a user equipment (UE) is configured to transmit a request to a network indicating an interest to receive a multicast and broadcast services (MBS) broadcast from a cell of the network, wherein the cell is, when the request is transmitted, a secondary cell (SCell) of the UE, the request including identifying information for the cell including a cell index or frequency, receive SCell MBS reception related information from the network within a timer duration and receive the MBS broadcast from the SCell based on the SCell MBS reception related information.

In a twentieth example, the processor of the nineteenth example, wherein the SCell MBS reception related information includes an MBS control channel (MCCH) payload of the SCell provided directly to the UE.

In a twenty first example, the processor of the twentieth example, further configured to receive an MBS traffic channel (MTCH) on the SCell based on the MCCH.

In a twenty second example, the processor of the nineteenth example, wherein the SCell MBS reception related information includes scheduling information for an MBS traffic channel (MTCH) of the SCell provided directly to the UE.

In a twenty third example, the processor of the twenty second example, further configured to receive the MTCH on the SCell based on the scheduling information for the MTCH.

In a twenty fourth example, the processor of the nineteenth example, wherein the SCell MBS reception related information includes scheduling information for a system information block 20 (SIB-20) on the SCell.

In a twenty fifth example, the processor of the twenty

fourth example, further configured to receive a control resource set (CORESET) and search space for the SIB-20 of the SCell via dedicated signaling.

In a twenty sixth example, the processor of the twenty

fourth example, further configured to receive a control resource set (CORESET) and search space for the SIB-20 of the SCell via a broadcast.

In a twenty seventh example, the processor of the twenty fourth example, further configured to receive the SIB-20 on the SCell based on the scheduling information for the SIB-20, receive an MBS control channel (MCCH) on the SCell based on the SIB-20 and receive an MBS traffic channel (MTCH) on the SCell based on the MCCH.

In a twenty eighth example, a user equipment (UE) comprises a transceiver configured to communicate with a network and a processor communicatively coupled to the transceiver and configured to transmit a request to a network indicating an interest to receive a multicast and broadcast services (MBS) broadcast from a cell of the network, wherein the cell is, when the request is transmitted, a secondary cell (SCell) of the UE, the request including identifying information for the cell including a cell index or frequency, receive SCell MBS reception related information from the network within a timer duration and receive the MBS broadcast from the SCell based on the SCell MBS reception related information.

In a twenty ninth example, a processor of a base station is configured to receive a request from a user equipment (UE) indicating an interest to receive a multicast and broadcast services (MBS) broadcast from a cell, wherein the cell is, when the request is transmitted, a secondary cell (SCell) of the UE, the request including identifying information for the cell including the cell index or frequency, transmit SCell MBS reception related information to the UE and transmit the MBS broadcast from the SCell.

In a thirtieth example, the processor of the twenty ninth example, wherein the SCell MBS reception related information includes an indication of a cell index or serving frequency information of the SCell.

In a thirty first example, the processor of the twenty ninth example, wherein the SCell MBS reception related information includes system information block 20 (SIB-20) of the SCell provided via dedicated signaling.

In a thirty second example, the processor of the twenty ninth example, wherein the SCell MBS reception related information includes a system information block 20 (SIB-20) of the SCell provided via a response to an on-demand system information (SI) acquisition procedure message.

In a thirty third example, the processor of the twenty ninth example, wherein the SCell MBS reception related information includes an MBS control channel (MCCH) payload of the SCell provided directly to the UE.

In a thirty fourth example, the processor of the

twenty ninth example, wherein the SCell MBS reception related information includes scheduling information for an MBS traffic channel (MTCH) of the SCell provided directly to the UE.

In a thirty fifth example, the processor of the twenty

ninth example, wherein the SCell MBS reception related information includes scheduling information for a system information block 20 (SIB-20) of the SCell.

In a thirty sixth example, the processor of the thirty

fifth example, further configured to transmit a control resource set (CORESET) and search space for the SIB-20 of the SCell via dedicated signaling.

In a thirty seventh example, the processor of the thirty fifth example, further configured to transmit a control resource set (CORESET) and search space for the SIB-20 of the SCell via a broadcast.

In a thirty eighth example, a base station comprises a transceiver configured to communicate with a user equipment (UE) and a processor communicatively coupled to the transceiver and configured to receive a request from the UE indicating an interest to receive a multicast and broadcast services (MBS) broadcast from a cell, wherein the cell is, when the request is transmitted, a secondary cell (SCell) of the UE, the request including identifying information for the cell including the cell index or frequency, transmit SCell MBS reception related information to the UE and transmit the MBS broadcast from the SCell.

In a thirty ninth example, a user equipment (UE) comprises a transceiver configured to communicate with a network and a processor communicatively coupled to the transceiver and configured to transmit a request to the network indicating an interest to receive a multicast and broadcast services (MBS) broadcast from a cell of the network, wherein the cell is, when the request is transmitted, a secondary cell (SCell) of the UE, the request including identifying information for the cell including a cell index or frequency, receive a network reconfiguration within a timer duration wherein the cell is reconfigured from an SCell to a primary cell (PCell) and receive the MBS broadcast from the PCell.

In a fortieth example, a processor of a base station is configured to receive a request from a user equipment (UE) indicating an interest to receive a multicast and broadcast services (MBS) broadcast from a cell of the network, wherein the cell is, when the request is transmitted, a secondary cell (SCell) of the UE, the request including identifying information for the cell including a cell index or frequency, transmit a network reconfiguration wherein the cell is reconfigured from an SCell to a primary cell (PCell) and transmit the MBS broadcast from the PCell.

In a forty first example, the processor of the fortieth example, wherein the network reconfiguration does not include a system information block 20 (SIB-20) of the PCell.

In a forty second example, the processor of the fortieth example, wherein the network reconfiguration includes a system information block (SIB-20) of the PCell.

In a forty third example, a base station comprises a transceiver configured to communicate with a user equipment (UE) and a processor communicatively coupled to the transceiver and configured to receive a request from the UE indicating an interest to receive a multicast and broadcast services (MBS) broadcast from a cell of the network, wherein the cell is, when the request is transmitted, a secondary cell (SCell) of the UE, the request including identifying information for the cell including a cell index or frequency, transmit a network reconfiguration wherein the cell is reconfigured from an SCell to a primary cell (PCell) and transmit the MBS broadcast from the PCell.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to:
transmit a request to a network indicating an interest to receive a multicast and broadcast services (MBS) broadcast from a serving cell of the network, wherein the request includes identifying information for the serving cell including a cell index or frequency;
determine whether a network response is received prior to expiration of a timer duration;
when the network response is received before the expiration of the timer duration, acquire information for receiving the MBS broadcast from the serving cell; and
when the network response is not received before the expiry of the timer, perform operations triggered by the expiry of the timer.

2. The processor of claim 1, wherein the serving cell is, when the request is transmitted, a secondary cell (SCell) of the UE.

3. The processor of claim 1, wherein the request further includes an MBS service identifier.

4. The processor of claim 1, wherein the request is included in an MBS Interest Indication (MII) message.

5. The processor of claim 4, wherein the MII message is enabled for the UE when the UE receives from the network an explicit SCell MBS reception indication.

6. The processor of claim 1, wherein the request is included in UE assistance information (UAI) or another layer 1 (L1), layer 2 (L2) or layer 3 (L3) message.

7. The processor of claim 1, wherein the request is included in an on-demand system information (SI) acquisition procedure message.

8. The processor of claim 1, wherein the request is triggered when the network indicates it can provide MBS related system information to the UE via dedicated signaling or the network indicates it can provide the MBS related system information to the UE in response to a MBS interest indication (MII) trigger, wherein the MBS related system information comprises system information block 20 (SIB-20) on a secondary cell (SCell).

9. (canceled)

10. The processor of claim 1, wherein, prior to sending the request, the UE attempts to receive system information block 20 (SIB-20) on a secondary cell (SCell) by UE implementation.

11. A processor of a user equipment (UE) configured to:
transmit a request to a network indicating an interest to receive a multicast and broadcast services (MBS) broadcast from a cell of the network, wherein the cell is, when the request is transmitted, a secondary cell (SCell) of the UE, the request including identifying information for the cell including a cell index or frequency;
receive SCell MBS reception related information from the network within a timer duration; and
receive the MBS broadcast from the SCell based on the SCell MBS reception related information.

12. The processor of claim 11, wherein the SCell MBS reception related information includes an indication of a cell index or serving frequency information of the SCell.

13. The processor of claim 11, wherein the SCell MBS reception related information includes system information block 20 (SIB-20) of the SCell provided via dedicated signaling.

14. The processor of claim 13, further configured to:
receive an MBS control channel (MCCH) on the SCell based on the SIB-20; and
receive an MBS traffic channel (MTCH) on the SCell based on the MCCH.

15. The processor of claim 11, wherein the SCell MBS reception related information includes system information block 20 (SIB-20) of the SCell provided via a response to an on-demand system information (SI) acquisition procedure message.

16. The processor of claim 15, further configured to:
receive an MBS control channel (MCCH) on the SCell based on the SIB-20; and
receive an MBS traffic channel (MTCH) on the SCell based on the MCCH.

17. A processor of a user equipment (UE) configured to:
transmit a request to a network indicating an interest to receive a multicast and broadcast services (MBS) broadcast from a cell of the network, wherein the cell is, when the request is transmitted, a secondary cell (SCell) of the UE, the request including identifying information for the cell including a cell index or frequency;
receive a network reconfiguration within a timer duration wherein the cell is reconfigured from an SCell to a primary cell (PCell); and
receive the MBS broadcast from the PCell.

18. The processor of claim 17, wherein the network reconfiguration does not include a system information block 20 (SIB-20) of the PCell.

19. The processor of claim 18, further configured to:
receive the SIB-20 on the PCell;
receive an MBS control channel (MCCH) on the PCell based on the SIB-20; and
receive an MBS traffic channel (MTCH) on the PCell based on the MCCH.

20. The processor of claim 17, wherein the network reconfiguration includes a system information block 20 (SIB-20) of the PCell.

21. The processor of claim 20, further configured to:
receive an MBS control channel (MCCH) on the PCell based on the SIB-20; and
receive an MBS traffic channel (MTCH) on the PCell based on the MCCH.
